(19) United States
(12) Patent Application Publication
(10) Pub. No.: US 2022/0323304 A1
(43) Pub. Date: Oct. 13, 2022

(54) IN VIVO TUBE INTRODUCTION DETERMINATION DEVICE

(71) Applicant: SHIMADZU CORPORATION, KYOTO (JP)

(72) Inventor: Hiroshi OKUMURA, KYOTO (JP)

(73) Assignee: SHIMADZU CORPORATION, KYOTO (JP)

(21) Appl. No.: 17/642,678

(22) PCT Filed: Oct. 17, 2019
(86) PCT No.: PCT/JP2019/040886

§ 371 Date: Mar. 12, 2022

(51) Int. Cl. A61J 15/00

(52) U.S. Cl. CPC A61J 15/0084; A61J 15/0003

(57) ABSTRACT

An in vivo tube introduction determination device (100) includes a gas detection unit (10) that is connected to a second end (302) of a tube (300) of which a first end (301) is inserted into the living body (200) and a notification unit (20) that provides notification of information based on the output of the gas detection unit (10). The gas detection unit (10) is configured to detect a concentration of a first gas component that is carbon dioxide or oxygen and a concentration of a second gas component having a concentration difference between the stomach and the esophagus.

### TECHNICAL FIELD

The present invention relates to an in vivo tube introduction determination device.

### BACKGROUND ART

Conventionally, there has been known a technique of inserting a tube into a living body. Such a technique is disclosed in, for example, Kazuya Omura, Daisuke Ono, Takahisa. Kawashima, Takayuki Kato, Yuriko Fujita, Ytisulke Itagaki, Yukiko Watanabe, and Noboru Ishii, “The serious complication with feeding tube: a case of esophageal perforation”, the Journal of the Japanese Society of Intensive Care Medicine, 2011, Vol. 18, No. 3, pp. 401 to 404 (hereinafter, simply referred to as “The serious complication with feeding tube: a case of esophageal perforation”).

The above-described “The serious complication with feeding tube: a case of esophageal perforation” discloses that a nasogastric feeding tube is inserted into a patient, and the insertion state of the nasogastric feeding tube is confirmed by simple chest X-ray examination and auscultation.

### CITATION LIST

Non-Patent Literature (NPL)

[NPL 1] Kazuya Omura, Daisuke Ono, Takahisa Kawashima, Takayuki Kato, Yuriko Fujita, Yusuke Itagaki, Yukiko Watanabe, and Noboru Ishii, “The serious complication with feeding tube: a case of esophageal perforation”, the Journal of the Japanese Society of Intensive Care Medicine, 2011, Vol. 18, No. 3, pp. 401 to 404

### SUMMARY OF INVENTION

### Technical Problem

Whereas, in a case where the simple chest X-ray examination is performed as disclosed in the above-described “The serious complication with feeding tube: a case of esophageal perforation”, the insertion state of the tube cannot be easily confirmed because it is necessary to perform X-ray imaging. In addition, in a case where the auscultation is performed, the insertion state of the tube cannot be reliably confirmed because gastric bubbling sound is not generated unless the tip of the tube is in contact with stomach juice. Further, with any of the above-described methods, the insertion state of the tube cannot be confirmed while the tube is being inserted into a living body. Therefore, it has been desired to easily and reliably confirm the insertion state of the tube and to confirm the insertion state of the tube while the tube is being inserted into the living body.

The present invention has been made to solve the above-described problems, and one object of the present invention is to provide an in vivo tube introduction determination device that can easily and reliably confirm the insertion state of a tube and that can confirm the insertion state of the tube while the tube is being inserted into a living body.

### Solution to Problem

In order to achieve the above-described object, there is provided an in vivo tube introduction determination device in one aspect of the present invention including: a gas detection unit that is connected to a second end of a tube having a first end and the second end, the first end being inserted into a living body; and a notification unit that provides notification of information based on an output of the gas detection unit, in which the gas detection unit is configured to detect a concentration of a first gas component that is carbon dioxide or oxygen and a concentration of a second gas component having a concentration difference between a stomach and an esophagus.

### Advantageous Effects of Invention

According to the present invention, with the above-described configuration, the notification unit can notify a user of the information based on the output of the concentration of the first gas component and the information based on the output of the concentration of the second gas component. As a result, the user can confirm whether the tube is positioned in the respiratory tract of the living body or a position other than the respiratory tract on the basis of the information based on the output of the concentration of the first gas component of which the user is notified, and can confirm whether the tube is positioned in the stomach or the esophagus on the basis of the information based on the output of the concentration of the second gas component of which the user is notified. As a result, the insertion state of the tube can be easily and reliably confirmed, and the insertion state of the tube can be confirmed while the tube is being inserted into the living body.

### BRIEF DESCRIPTION OF DRAWINGS

FIG. 1 is a schematic view showing an overall configuration of an in vivo tube introduction determination device.

FIG. 2 is a block diagram showing a controllable configuration of the in vivo tube introduction determination device.

FIG. 3 is a schematic view showing attachment of a tube to the in vivo tube introduction determination device.

FIG. 4 is a schematic view showing a gas flow from an inside of a living body to the in vivo tube introduction determination device.

FIG. 5A is a view illustrating a case where a tip of the tube is positioned in a respiratory tract.

FIG. 5B is a schematic view showing a display example of the in vivo tube introduction determination device in the case of FIG. 5A.

FIG. 6A is a view illustrating a case where the tip of the tube is positioned in an esophagus.

FIG. 6B is a schematic view showing a display example of the in vivo tube introduction determination device in the case of FIG. 6A.

FIG. 7A is a view illustrating a case where the tip of the tube is positioned in a stomach.

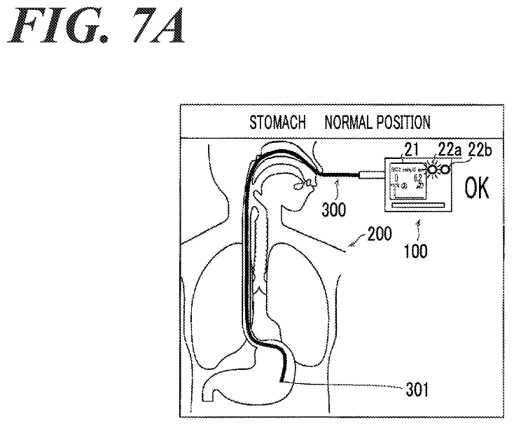

FIG. 7B is a schematic view showing a display example of the in vivo tube introduction determination device in the case of FIG. 7A.

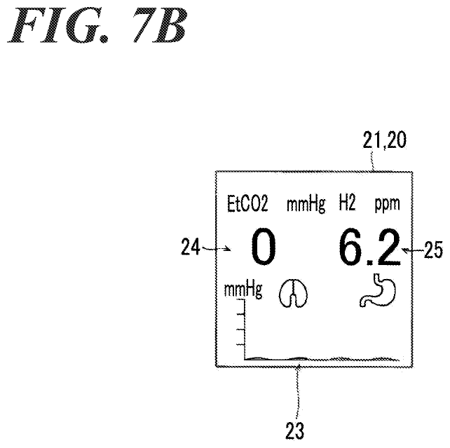

### DESCRIPTION OF EMBODIMENTS

Hereinafter, embodiments embodying the present invention will be described with reference to the drawings.

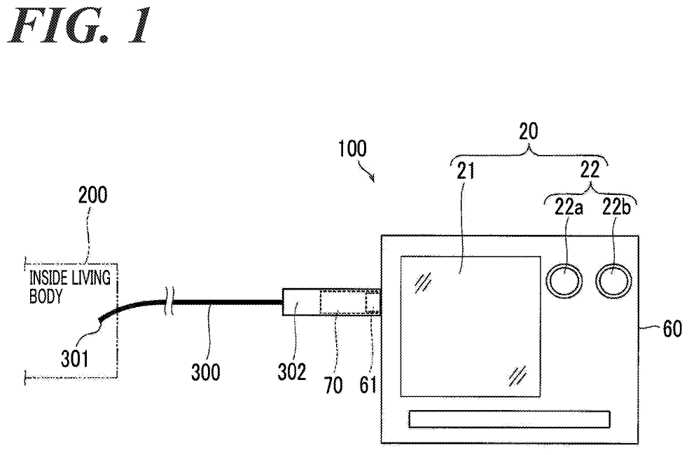

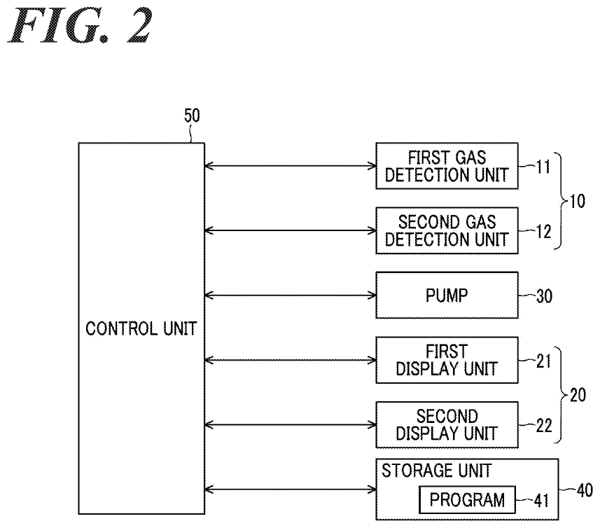

An in vivo tube introduction determination device 100 according to an embodiment will be described with reference to FIGS. 1 and 2.

(In Vivo Tube Introduction Determination Device) As shown in FIG. 1, the in vivo tube introduction determination device 100 is a device that is used to determine the introduction state (insertion state) of a tube 300 in a living body 200.

The tube 300 is a tube that is inserted into the stomach of the living body 200, which is a human body, via the nose or the mouth. The tube 300 may be, for example, a feeding tube that is used to inject an injection such as a nutrient into the stomach of the living body 200, and a drainage tube that is used to discharge contents such as body fluid from stomach of the living body 200. The tube 300 has a first end 301 and a second end 302. The first end 301 is inserted into the living body 200 via the nose or the mouth and is indwelled in the stomach. The second end 302 is disposed outside the living body 200 and may be connected to a bag such as a nutrition bag or a drainage bag. In the present embodiment, when the tube 300 is inserted into the living body 200, the second end 302 is attached to the in vivo tube introduction determination device 100.

As shown in FIGS. 1 and 2, the in vivo tube introduction determination device 100 includes a gas detection unit 10, a display unit 20, a pump 30, a storage unit 40, and a control unit 50. The gas detection unit 10, at least a part of the display unit 20, the pump 30, the storage unit 40, and the control unit 50 are provided inside a housing 60 that forms the exterior of the in vivo tube introduction determination device 100. The display unit 20 is an example of the “notification unit” in the claims.

The gas detection unit 10 is configured to detect the concentration of a gas component in the living body 200. The gas detection unit 10 is connected to the second end 302 of the tube 300. The gas detection unit 10 is configured to detect the concentration of carbon dioxide that is a first gas component and the concentration of hydrogen that is a second gas component having a concentration difference between the stomach and the esophagus. Specifically, the gas detection unit 10 includes a first gas detection unit 11 that is able to detect the concentration of the first gas component (carbon dioxide) and a second gas detection unit 12 that is able to detect the concentration of the second gas component (hydrogen). The first gas detection unit 11 and the second gas detection unit 12 are sensors provided independently of each other. The first gas detection unit 11 need only be a sensor capable of detecting at least the first gas component. That is, the first gas detection unit 11 may be a sensor capable of detecting only the first gas component (carbon dioxide) or may be a sensor capable of detecting a plurality of gas components including the first gas component. Similarly, the second gas detection unit 12 need only be a sensor capable of detecting at least the second gas component. That is, the second gas detection unit 12 may be a sensor that detects only the second gas component (hydrogen) or may be a sensor that detects a plurality of gas components including the second gas component.

The display unit 20 is configured to provide notification of information based on the output of the gas detection unit 10. Specifically, the display unit 20 includes a first display unit 21 that provides notification of information based on the output of the gas detection unit 10 with screen display (image) and a second display unit 22 that provides notification of information based on the output of the gas detection unit 10 with light. The first display unit 21 includes, for example, a monitor, and is configured to provide notification by displaying information such as a numerical value and a graph. The second display unit 22 includes, for example, a light source unit such as a light emitting diode (LED) and is configured to provide notification of information through the lighting state of the light source unit. Further, the second display unit 22 has two lighting units of a first lighting unit 22a and a second lighting unit 22b. The details of the notification of information based on the output of the gas detection unit 10 will be described later.

The pump 30 is configured to suck the gas in the living body 200 from the first end 301 of the tube 300 and to introduce the sucked gas in the living body 200 into the gas detection unit 10. The pump 30 is not particularly limited, but for example, an electric pump such as a pump using either a fan or a tube pump may be used.

The storage unit 40 includes a recording medium such as a volatile memory and a non-volatile memory and is configured to store information. The storage unit 40 stores a program 41 that is used to operate the in vivo tube introduction determination device.

The control unit 50 includes a processor such as a CPU and is configured to execute the program 41. With this, the control unit 50 is configured to operate each unit of the in vivo tube introduction determination device. Further, the control unit 50 is configured to perform control of sequentially reading out the outputs of the first gas detection unit 11 and the second gas detection unit 12 of the gas detection unit 10 and of storing the outputs on the storage unit 40 together with the time. Further, the control unit 50 is configured to perform control of displaying processed data in which data stored on the storage unit 40 is read out and processed, on the first display unit 21 of the display unit 20.

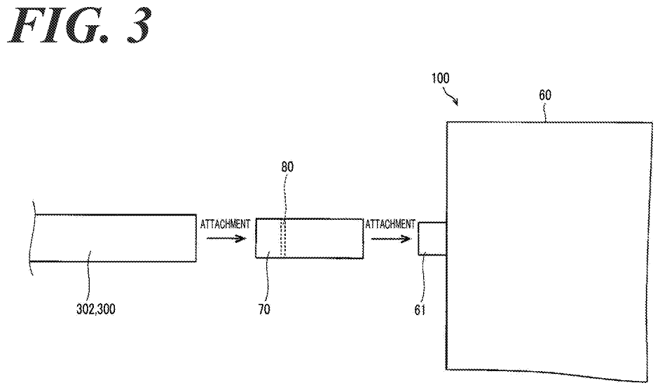

(Attachment of Tube) As shown in FIG. 3, the housing 60 is provided with an introduction inlet 61 to which the second end 302 of the tube 300 is connected. The introduction inlet 61 is a through-hole via which the inside and outside of the housing 60 are connected to each other. The gas in the living body 200 is introduced into the housing 60 via the introduction inlet 61. Further, a joint member 70 is provided between the second end 302 of the tube 300 and the introduction inlet 61. The second end 302 of the tube 300 is attached to the introduction inlet 61 via the joint member 70. Further, the joint member 70 is provided with a filter 80 that is used to prevent an infectious disease. The filter 80 may be, for example, a filter capable of collecting pathogens, such as a high efficiency particulate air (HEM) filter. The joint member 70 and the filter 80 are disposable and are replaced each time the joint member 70 and the filter 80 are used. The filter 80 is disposed near the introduction inlet 61.

(Gas Flow from Inside of Living Body)

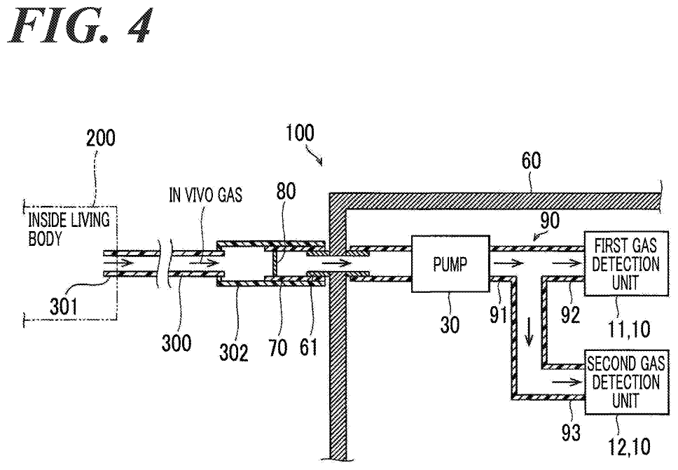

As shown in FIG. 4, in the housing 60, the pump 30, and the first gas detection unit 11 and the second gas detection unit 12 of the gas detection unit 10 are connected to each other via a branch flow path 90. The branch flow path 90 includes a common end 91 connected to the output side of the pump 30, a first branch end 92 connected to the first gas detection unit 11 of the gas detection unit 10, and a second branch end 93 connected to the second gas detection unit 12 of the gas detection unit 10. The gas in the living body 200 is introduced from the first end 301 of the tube 300, and then flows through the inside of the tube 300, the second end 302 of the tube 300, the joint member 70, the introduction inlet 61, and the branch flow path 90 in this order and is introduced into the first gas detection unit 11 or the second gas detection unit 12. When the gas passes through the joint member 70, pathogens are collected from the gas in the living body 200 by the filter 80 provided in the joint member 70.

Since there is a concern that stomach juice or the like is sucked when the gas in the living body 200 is sucked by the pump 30, a gas permeable membrane that allows only the gas to permeate without allowing liquid to permeate may be provided in the middle of the flow path of the gas in the living body 200, such as the tube 300, the joint member 70, the pump 30, and the branch flow path 90. In this case, the filter 80 may function as the gas permeable membrane, or the gas permeable membrane may be provided independently of the filter 80.

(Notification of Information Based on Output of Gas Detection Unit)

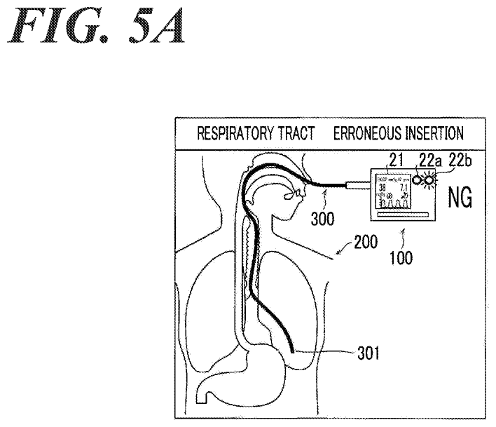

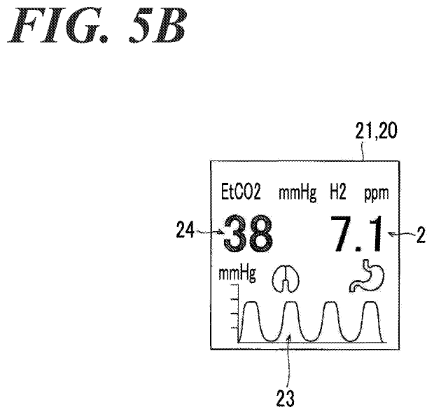

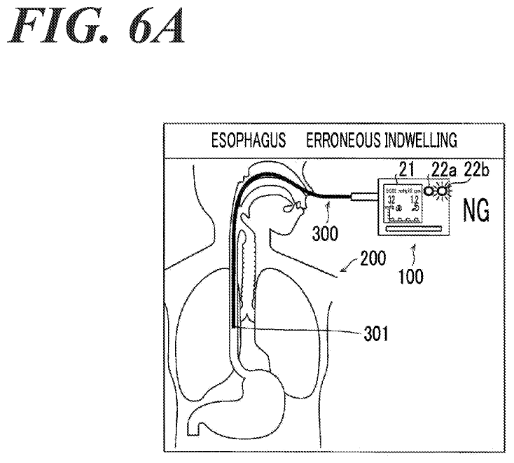

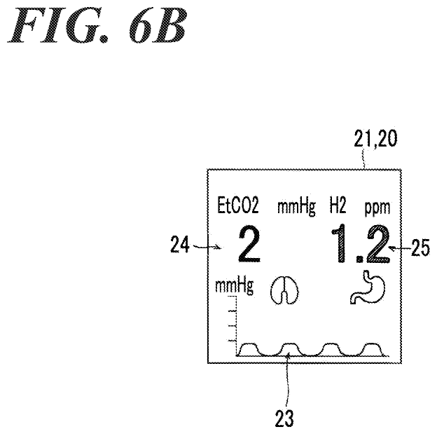

As shown in FIGS. 4 to 6, the first display unit 21 of the display unit 20 is configured to display a time corresponding to the concentration of the first gas component (carbon dioxide), a value 24 corresponding to the concentration of the first gas component, and a value 25 corresponding to the concentration of the second gas component (hydrogen). Specifically, the first display unit 21 of the display unit 20 is configured to display the time change 23 of the value corresponding to the concentration of the first gas component in a time-series graph. Further, the first display unit 21 of the display unit 20 is configured to display the value 24 corresponding to the concentration of the first gas component and the value 25 corresponding to the concentration of the second gas component in real time.

The second gas component (hydrogen) is a gas component generated by the intestinal flora and has different concentrations in the stomach and the esophagus. Specifically, the concentration of the second gas component in the stomach is higher than the concentration of the second gas component in the esophagus. This is because the lower esophageal sphincter and the cardia existing between the stomach and the esophagus of the living body 200 obstruct the flow of gas from the stomach to the esophagus. Therefore, the user can determine whether the first end 301 of the tube 300 is positioned in the stomach or the esophagus by visually confirming the value 25 corresponding to the concentration of the second gas component. However, there is a concern that in a case where only the value 25 corresponding to the concentration of the second gas component is displayed, determination may be made that the first end 301 of the tube 300 is positioned in the stomach even though the first end 301 is positioned in the lung (respiratory tract) because the hydrogen that is the second gas component is also generated in the lung.

Therefore, the time change 23 of the value corresponding to the concentration of the first gas component (carbon dioxide) is displayed together with the value 25 corresponding to the concentration of the second gas component. Since the concentration of the first gas component is changed periodically with time so as to correspond to the respiratory cycle of the living body 200 in a case where the first end 301 of the tube 300 is positioned in the lung (respiratory tract), the time change 23 of the value corresponding to the concentration of the first gas component is confirmed, so that it is possible to determine whether the first end 301 of the tube 300 is positioned in the lung (respiratory tract) or a position other than the respiratory tract.

In this case, the control unit 50 reads the output of the first gas detection unit 11 of the gas detection unit 10 for the latest predetermined time out of the storage unit 40 and controls the first display unit 21 of the display unit 20 to display the time change 23 of the value corresponding to the concentration of the first gas component (carbon dioxide) for the latest predetermined time in a time-series line graph. The predetermined time read out of the storage unit 40 is longer than the time for one cycle of the respiratory cycle of the living body 200, and is time predetermined by an experiment or the like. The predetermined time is preferably time including a plurality of respiratory cycles of the living body 200 from the viewpoint of reliably determining the erroneous insertion of the tube 300 into the respiratory tract of the living body 200. The predetermined time may be, for example, about 30 seconds.

Further, the control unit 50 reads the latest output of the first gas detection unit 11 of the gas detection unit 10 and the latest output of the second gas detection unit 12 of the gas detection unit 10 out of the storage unit 40, and controls the first display unit 21 of the display unit 20 to display the value 24 corresponding to the latest concentration of the first gas component (carbon dioxide) and the value 25 corresponding to the latest concentration of the second gas component (hydrogen).

Further, in the present embodiment, the control unit 50 is configured to automatically determine the insertion stat of the tube 300. Specifically, the control unit 50 is configured to perform control of determining whether the first end 301 of the tube 300 is positioned in the respiratory tract of the living body 200 or a position other than the respiratory tract on the basis of the concentration of the first gas component (carbon dioxide). More specifically, the control unit 50 performs control of determining that the first end 301 of the tube 300 is positioned in the respiratory tract of the living body 200 in a case where the concentration of the first gas component fluctuates periodically. Alternatively, the control unit 50 performs control of determining that the first end 301 of the tube 300 is positioned in a position other than the respiratory tract of the living body 200 in a case where the concentration of the first gas component does not fluctuate periodically. Whether or not the concentration of the first gas component fluctuates periodically may be determined by Fourier transform of the output of the first gas detection unit 11 of the gas detection unit 10.

Further, the control unit 50 is configured to perform control of determining whether the first end 301 of the tube 300 is positioned in the stomach or the esophagus on the basis of the concentration of the second gas component (hydrogen) in a case where the control unit 50 determines that the first end 301 of the tube 300 is positioned in a position other than the respiratory tract of the living body 200. In this case, for example, the control unit 50 performs control of comparing the concentration of the second gas component with a threshold value. The control unit 50 performs control of determining that the first end 301 of the tube 300 is positioned in the esophagus in a case where the concentration of the second gas component is the threshold value or less. Alternatively, the control unit 50 performs control of determining that the first end 301 of the tube 300 is positioned in the stomach in a case where the concentration of the second gas component is larger than the threshold value. The threshold value may be decided and stored on the basis of the output of the first gas detection unit 11 in a case where the first end 301 of the tube 300 is confirmed to be normally positioned in the stomach, or a standard value may be stored as the threshold value.

The control unit 50 may perform control of determining whether the first end 301 of the tube 300 is positioned in the stomach or the esophagus on the basis of the concentration change (difference in concentration) of the second gas component, not on the basis of the absolute value of the concentration of the second gas component. The control unit 50 performs control of determining that the first end 301 of the tube 300 is positioned in the stomach in a case where the concentration of the second gas component suddenly increases. Alternatively, the control unit 50 performs control of determining that the first end 301 of the tube 300 is positioned in the esophagus in a case where the concentration of the second gas component does not suddenly increase. With this, accurate determination can be made even in a case where the individual difference in the concentration of the second gas component is large and a case where the difference in the concentration of the second gas component is large depending on the physical condition even within one individual.

The display unit 20 is configured to provide notification of the determination result as to whether the first end 301 of the tube 300 is positioned in the respiratory tract of the living body 200 or a position other than the respiratory tract and the determination result as to whether the first end 301 of the tube 300 is positioned in the stomach or the esophagus. Specifically, the first display unit 21 of the display unit 20 is configured to provide notification of the determination result with screen display. The notification using screen display is not particularly limited, but may be, for example, notification using character display such as “NG” or “OK”. Alternatively, the notification using screen display may be, for example, notification using color display of the displayed values (values 24 and 25). In this case, for example, it is possible to provide notification by displaying the value 24 corresponding to the concentration of the first gas component (carbon dioxide) in a color different from the usual color, in a case where determination is made that the first end 301 of the tube 300 is positioned in the respiratory tract. Similarly, it is possible to provide notification by displaying the value 25 corresponding to the concentration of the second gas component (hydrogen) in a color different from the usual color, in a case where determination is made that the first end 301 of the tube 300 is positioned in the esophagus. Similarly, it is possible to provide notification by displaying both the value 24 corresponding to the concentration of the first gas component and the value 25 corresponding to the concentration of the second gas component in the same color as usual, in a case where determination is made that the first end 301 of the tube 300 is positioned in the stomach.

Further, the second display unit 22 of the display unit 20 is configured to provide notification of the determination result through the lighting state. Specifically, the second display unit 22 is configured to turn on only the second lighting unit 22b indicating that the first end 301 of the tube 300 is not positioned in the stomach, out of the first lighting unit 22a and the second lighting unit 22b, in a case where determination is made that the first end 301 of the tube 300 is positioned in the respiratory tract and a case where the first end 301 of the tube 300 is positioned in the esophagus. Further, the second display unit 22 is configured to turn on only the first lighting unit 22a indicating that the first end 301 of the tube 300 of the second display unit is positioned in the stomach, out of the first lighting unit 22a and the second lighting unit 22b, in a case where determination is made that the first end 301 of the tube 300 is positioned in the stomach.

(Effect of Present Embodiment)

In the present embodiment, the following effects can be obtained.

In the present embodiment, as described above, the in vivo tube introduction determination device 100 includes the gas detection unit 10 that is connected to the second end 302 of the tube 300 having the first end 301 and the second end 302, the first end 301 being inserted into the living body 200; and the display unit 20 that provides notification of the information based on the output of the gas detection unit 10. The gas detection unit 10 is configured to detect the concentration of the first gas component that is carbon dioxide and the concentration of the second gas component having a concentration difference between the stomach and the esophagus. With this, the display unit 20 can notify the user of the information based on the output of the concentration of the first gas component and the information based on the output of the concentration of the second gas component. As a result, the user can confirm whether the tube 300 is positioned in the respiratory tract of the living body 200 or a position other than the respiratory tract on the basis of the information based on the output of the concentration of the first gas component of which the user is notified, and can confirm whether the tube 300 is positioned in the stomach or the esophagus on the basis of the information based on the output of the concentration of the second gas component of which the user is notified. As a result, the insertion state of the tube 300 can be easily and reliably confirmed, and the insertion state of the tube 300 can be confirmed while the tube 300 is being inserted into the living body 200.

Further, in the present embodiment, as described above, the gas detection unit 10 includes the first gas detection unit 11 that is able to detect the concentration of the first gas component and the second gas detection unit 12 that is able to detect, the concentration of the second gas component. With this, the concentration of the first gas component and the concentration of the second gas component can be detected by separate gas detection units (that is, the first gas detection unit 11 and the second gas detection unit 12), so that each of the concentration of the first gas component and the concentration of the second gas component n be accurately detected.

Further, in the present embodiment, as described above, the first gas component is carbon dioxide. With this, carbon dioxide having a lower concentration in the air than oxygen is used as the first gas component, so that it is possible to easily detect the change in the concentration of the first gas component as compared with the case where oxygen is used as the first gas component. As a result, it is possible to easily confirm whether the tube 300 is positioned in the respiratory tract of the living body 200 or a position other than the respiratory tract.

Further, in the present embodiment, as described above, the second gas component is hydrogen. With this, hydrogen having a large difference between the concentration in the air and the concentration in the stomach is used as the second gas component, out of the second gas components (methane and the like) having a concentration difference between the stomach and the esophagus, so that it is possible to easily detect the change in the concentration of the second gas component as compared with the case where the methane or the like is used as the second gas component, even in a case where the living body 200 that is a patient swallows the air. As a result, it is possible to easily confirm whether the tube 300 is positioned in the stomach or the esophagus of the living body 200. As an example, when hydrogen and methane are compared with each other, the concentration of hydrogen in the air is about 0.5 ppm and the concentration of methane in the air is about 1.8 ppm, whereas the concentration of hydrogen in the stomach is about 5 to 10 ppm and the concentration of methane in the stomach is about 2 to 3 ppm.

Further, in the present embodiment, as described above, the display unit 20 is configured to display the time change 23 of the value corresponding to the concentration of the first gas component and the value 25 corresponding to the concentration of the second gas component. With this, the user can confirm whether or not the concentration of the first gas component fluctuates periodically on the basis of the time change 23 of the value corresponding to the concentration of the first gas component displayed on the display unit 20, so that it is possible to easily confirm whether the tube 300 is positioned in the respiratory tract of the living body 200 or a position other than the respiratory tract on the basis of whether or not the concentration of the first gas component fluctuates periodically. Further, the user can confirm the magnitude of the concentration of the second gas component on the basis of the value 25 corresponding to the concentration of the second gas component displayed on the display unit 20, so that it is possible to easily confirm whether the tube 300 is positioned in the stomach or the esophagus of the living body 200 on the basis of the magnitude of the concentration of the second gas component.

Further, in the present embodiment, as described above, the display unit 20 is configured to display the time change 23 of the value corresponding to the concentration of the first gas component in a time-series graph. With this, the user can easily and reliably confirm whether or not the concentration of the first gas component fluctuates periodically on the basis of the time change 23 of the value corresponding to the concentration of the first gas component displayed on the display unit 20 in the time-series graph.

Further, in the present embodiment, as described above, the display unit 20 is configured to display the value 25 corresponding to the concentration of the second gas component in real time. With this, the user can easily confirm the magnitude of the concentration of the second gas component in real time on the basis of the value 25 corresponding to the concentration of the second gas component displayed in real time on the display unit 20.

Further, in the present embodiment, as described above, the control unit 50 is configured to perform control of determining whether the first end 301 of the tube 300 is positioned in the respiratory tract of the living body 200 or a position other than the respiratory tract on the basis of the concentration of the first gas component. With this, the control unit 50 can automatically determine whether the first end 301 of the tube 300 is positioned in the respiratory tract of the living body 200 or a position other than the respiratory tract, so that it is possible to reduce the time and effort for the user to determine whether the first end 301 of the tube 300 is positioned in the respiratory tract of the living body 200 or a position other than the respiratory tract.

Further, in the present embodiment, as described above, the control unit 50 is configured to perform control of determining whether the first end 301 of the tube 300 is positioned in the stomach or the esophagus on the basis of the concentration of the second gas component in a case where the control unit 50 determines that the first end 301 of the tube 300 is positioned in a position other than the respiratory tract of the living body 200. With this, the control unit 50 can automatically determine whether the first end 301 of the tube 300 is positioned in the stomach or the esophagus, so that it is possible to reduce the time and effort for the user to determine whether the first end 301 of the tube 300 is positioned in the stomach or the esophagus. Further, whether the first end 301 of the tube 300 is positioned in the stomach or the esophagus is determined in a case where determination is made that the first end 301 of the tube 300 is positioned in a position other than the respiratory tract of the living body 200, so that it is possible to more reliably determine whether the first end 301 of the tube 300 is positioned in the stomach or the esophagus.

Further, in the present embodiment, as described above, the display unit 20 is configured to provide notification of the determination result as to whether the first end 301 of the tube 300 is positioned in the respiratory tract of the living body 200 or a position other than the respiratory tract and the determination result as to whether the first end 301 of the tube 300 is positioned in the stomach or the esophagus. With this, the user can easily confirm the determination result as to whether the first end 301 of the tube 300 is positioned in the respiratory tract of the living body 200 or a position other than the respiratory tract and the determination result as to whether the first end 301 of the tube 300 is positioned in the stomach or the esophagus, so that it is possible to easily confirm the insertion state of the tube 300.

Further, in the present embodiment, as described above, the in vivo tube introduction determination device 100 includes the pump 30 that is used to suck the gas in the living body 200 from the first end 301 of the tube 300 and to introduce the sucked gas in the living body 200 into the gas detection unit 10. With this, the gas in the living body 200 can be quickly and reliably introduced into the gas detection unit 10 by the action of the pump 30, so that the gas detection unit 10 can detect the concentration of the first gas component and the concentration of the second gas component quickly and reliably.

Further, in the present embodiment, as described above, the in vivo tube introduction determination device 100 includes the filter 80 that is used to prevent an infectious disease. With this, it is possible to restrain the onset of the infectious disease via the in vivo tube introduction determination device 100 even in a case where the in vivo tube introduction determination device 100 is reused.

Further, in the present embodiment, as described above, the in vivo tube introduction determination device 100 includes the introduction inlet 61 of the gas in the living body 200 to which the second end 302 of the tube 300 is connected. Further, the filter 80 is disposable and is disposed near the introduction inlet 61. With this, the filter 80 can be made disposable, so that it is possible to more reliably restrain the onset of the infectious disease via the in vivo tube introduction determination device 100 as compared with the case where the filter 80 is reused. Further, with the filter 80 disposed near the introduction inlet 61, the disposable filter 80 can be easily attached and detached.

### Modification Example

It should be noted that the embodiment disclosed herein is an example in all respects and is not considered to be restrictive. The scope of the present invention is shown by the claims, not the description of the above-described embodiment, and includes all modifications (modification examples) within the meaning and scope equivalent to the claims.

For example, in the above-described embodiment, an example, in which the gas detection unit includes the first gas detection unit and the second gas detection unit, is shown, but the present invention is not limited thereto. In the present invention, the gas detection unit may be formed of a single gas detection unit that can detect both the first gas component and the second gas component.

Further, in the above-described embodiment, an example in which the first gas component is carbon dioxide is shown, hut the present invention is not limited thereto. In the present invention, the first gas component may be oxygen.

Further, in the above-described embodiment, an example, in which the second gas component is hydrogen, is shown, but the present invention is not limited thereto. In the present invention, the second gas component may be a gas component such as methane having a concentration difference between the stomach and the esophagus. The second gas component need only be a gas component generated by the presence of stomach juice or intestinal flora.

Further, in the above-described embodiment, an example, in which the display unit (notification unit) includes the first display unit and the second display unit, is shown, but the present invention is not limited thereto. In the present invention, in a case where the determination by the control unit is not performed, the notification unit may include only the first display unit out of the first display unit and the second display unit. Alternatively, in the present invention, in a case where the determination by the control unit is performed, the notification unit may include only the second display unit out of the first display unit and the second display unit. Alternatively, in this case, the notification unit may be configured to provide notification of the information based on the output of the gas detection unit with sound, vibration, or the like, without including the second display unit.

Further, in the above-described embodiment, an example in which the display unit displays both the time change of the value corresponding to the concentration of the first gas component and the value corresponding to the concentration of the first gas component, for the first gas component, is shown, but the present invention is not limited thereto. In the present invention, the display unit may display only one of the time changes of the value corresponding to the concentration of the first gas component and the value corresponding to the concentration of the first gas component, for the first gas component. However, it is preferable that the display unit displays the time change of the value corresponding to the concentration of the first gas component, from the viewpoint of making accurate determination.

Further, in the above-described embodiment, an example in which the control unit automatically determines the insertion state of the tube is shown, but the present invention is not limited thereto. In the present invention, the control unit may not necessarily automatically determine the insertion state of the tube. In this case, the user need only determine the insertion state of the tube on the basis of the information based on the output of the gas detection unit displayed on the display unit.

Further, in the above-described embodiment, an example in which the pump is provided in the in vivo tube introduction determination device is shown, but the present invention is not limited thereto. In the present invention, the pump does not necessarily have to be provided, for example, in a case where a high-sensitivity sensor capable of ensuring sufficient detection accuracy is used as the gas detection unit.

Further, in the above-described embodiment, an example in which the filter is provided in the in vivo tube introduction determination device is shown, but the present invention is not limited thereto. In the present invention, the filter does not necessarily have to be provided, for example, in a case where the risk of infectious disease is small.

Further, in the above-described embodiment, an example in which a joint member is provided in the in vivo tube introduction determination device is shown, but the present invention is not limited thereto. In the present invention, the joint member does not necessarily have to be provided. In this case, the second end of the tube need only be connected directly to the introduction inlet of the in vivo tube introduction determination device.

Further, in the above-described embodiment, an example in which the filter is provided in the joint member is shown, but the present invention is not limited thereto. In the present invention, the filter may be attachably and detachably provided in the introduction inlet of the in vivo tube introduction determination device so as to be disposable.

Further, in the above-described embodiment, an example in which the first gas detection unit and the second gas detection unit are provided in the branch flow path is shown, but the present invention is not limited thereto. In the present invention, the first gas detection unit and the second gas detection unit may be provided in a series flow path that does not branch. In this case, the gas in the living body passes, for example, in the order of the first gas detection unit and the second gas detection unit.

[Aspect] it will be appreciated by those skilled in the art that the above-described exemplary embodiments are specific examples of the following aspects.

(Item 1)

An in vivo tube introduction determination device including:

a gas detection unit that is connected to a second end of a tube having a first end and the second end, the first end being inserted into a living body; and

a notification unit that provides notification of information based on an output of the gas detection unit,

in which the gas detection unit is configured to detect a concentration of a first gas component that is carbon dioxide or oxygen and a concentration of a second gas component having a concentration difference between a stomach and an esophagus.

(Item 2)

The in vivo tube introduction determination device according to item 1, in which the gas detection unit includes a first gas detection unit that is able to detect the concentration of the first gas component and a second gas detection unit that is able to detect the concentration of the second gas component.

(Item 3)

The in vivo tube introduction determination device according to item 1 or 2, in which the first gas component is carbon dioxide.

(Item 4)

The in vivo tube introduction determination device according to any one of items 1 to 3,

in which the second gas component is hydrogen.

(Item 5)

The in vivo tube introduction determination device according to any one of items 1 to 4,

in which the notification unit includes a display unit, and

the display unit is configured to display a time change of a value corresponding to the concentration of the first gas component and a value corresponding to the concentration of the second gas component.

(Item 6)

The in vivo tube introduction determination device according to item 5,

in which the display unit is configured to display the time change of the value corresponding to the concentration of the first gas component in a time-series graph.

(Item 7)

The in vivo tube introduction determination device according to item 5 or 6,

in which the display unit is configured to display the value corresponding to the concentration of the second gas component in real time.

(Item 8)

The in vivo tube introduction determination device according to any one of items 1 to 7, further including:

a control unit,

in which the control unit is configured to perform control of determining whether the first end of the tube is positioned in a respiratory tract of the living body or a position other than the respiratory tract on the basis of the concentration of the first gas component.

(Item 9)

The in vivo tube introduction determination device according to item 8,

in which the control unit is configured to perform control of determining whether the first end of the tube is positioned in the stomach or the esophagus on the basis of the concentration of the second gas component, in a case where the control unit determines that the first end of the tube is positioned in the position other than the respiratory tract of the living body.

(Item 10)

The in vivo tube introduction determination device according to item 9,

in which the notification unit is configured to provide notification of a determination result as to whether the first end of the tube is positioned in the respiratory tract of the living body or the position other than the respiratory tract and a determination result as to whether the first end of the tube is positioned in the stomach or the esophagus.

(Item 11)

The in vivo tube introduction determination device according to any one of items 1 to 10, further including:

a pump that is used to suck gas in the living body from the first end of the tube and to introduce the sucked gas in the living body into the gas detection unit.

(Item 12)

The in vivo tube introduction determination device according to any one of items 1 to 11, further including:

a filter that is used to prevent an infectious disease.

(Item 13)

The in vivo tube introduction determination device according to item 12, further including:

an introduction inlet of gas in the living body to which the second end of the tube is connected,

in which the filter is disposable and is disposed near the introduction inlet.

### REFERENCE SIGNS LIST

10: gas detection unit
11: first gas detection unit
12: second gas detection unit
20: display unit (notification unit)
30: pump
50: control unit
61: introduction inlet
80: filter
200: living body
300: tube
301: first end
302: second end

1. An in vivo tube introduction determination device comprising:
a gas detection unit that is connected to a second end of a tube having a first end and said second end, said first end being inserted into a living body;
a notification unit that provides notification of information based on an output of said gas detection unit; and
wherein said gas detection unit detects a concentration of a first gas component that is carbon dioxide or oxygen and a concentration of a second gas component having a concentration difference between a stomach and an esophagus.

2. The in vivo tube introduction determination device, according to claim 1, wherein:
said gas detection unit further comprises a first gas detection unit that detects said concentration of said first gas component and a second gas detection unit that detects said concentration of said second gas component.

3. The in vivo tube introduction determination device, according to claim 1, wherein:
said first gas component is carbon dioxide.

4. The in vivo tube introduction determination device, according to claim 1, wherein:
said second gas component is hydrogen.

5. The in vivo tube introduction determination device, according to claim 1, wherein:
said notification unit further comprises a display unit; and
said display unit that displays a time change of a value corresponding to the concentration of said first gas component and a value corresponding to said concentration of said second gas component.

6. The in vivo tube introduction determination device, according to claim 5, wherein:
said display unit that displays said time change of said value corresponding to said concentration of said first gas component in a time-series graph.

7. The in vivo tube introduction determination device, according to claim 5, wherein:
said display unit that displays said value corresponding to said concentration of said second gas component in real time.

8. The in vivo tube introduction determination device, according to claim 1, further comprising:
a control unit; and
wherein said control unit performs control of determining whether said first end of said tube is positioned in a respiratory tract of said living body or a position other than said respiratory tract on the basis of said concentration of said first gas component.

9. The in vivo tube introduction determination device, according to claim 8, wherein:
said control unit performs control of determining whether said first end of said tube is positioned in said stomach or said esophagus on the basis of said concentration of said second gas component, in a case where said control unit determines that said first end of said tube is positioned in said position other than said respiratory tract of said living body.

10. The in vivo tube introduction determination device, according to claim 9, wherein:
said notification unit provides notification of a determination result as to whether said first end of said tube is positioned in said respiratory tract of said living body or said position other than said respiratory tract and a determination result as to whether said first end of said tube is positioned in said stomach or said esophagus.

11. The in vivo tube introduction determination device, according to claim 1, further comprising:
a pump that sucks gas in said living body from said first end of said tube and introduces a sucked gas in said living body into said gas detection unit.

12. The in vivo tube introduction determination device, according to claim 1, further comprising:
a filter that prevents an infectious disease.

13. The in vivo tube introduction determination device, according to claim 12, further comprising:
an introduction inlet of gas inside said living body to which said second end of said tube is connected; and
wherein said filter is disposable and is disposed near said introduction inlet.
